(19) United States
(12) Patent Application Publication
(10) Pub. No.: US 2005/0229374 A1
(43) Pub. Date: Oct. 20, 2005

(54) System and method for securing a captive rivet

(76) Inventor: John P. Franz, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/824,041

(22) Filed: Apr. 14, 2004

(51) Int. Cl. B23P 17/00

(52) U.S. Cl. 29/428; 227/51

(57) ABSTRACT

The present invention provides a system and method for securing a captive rivet to a material. Briefly described, one embodiment is a captive rivet comprising a captive rivet head; a captive rivet shank coupled to the captive rivet head; and at least one capture region disposed on a lower portion of the captive rivet shank.

### TECHNICAL FIELD

The present invention is generally related to fasteners and, more particularly, is related to a system and method for securing a captive rivet to a first material.

### BACKGROUND

Fastening two or more materials together with a rivet is a common practice in many manufacturing applications. FIG. 1 is a perspective view of a prior art standard tubular rivet 100. Rivet 100 has a rivet head 102 having an interior surface 104 and an exterior surface 106. Interior surface 104 is the surface of the rivet head 102 that contacts the material 202 (FIG. 2) during the riveting process, described below. The exterior surface 106 of rivet head 102 is supported by an anvil during the riveting process.

Rivet 100 further has a rivet shank 108 having a top portion 110. Since rivet 100 is a standard tubular rivet type, rivet shank 108 has an outside surface 112 and an inside surface 114. Rivet shank 108 has a bottom portion 116 that joins the rivet shank 108 and the rivet head 102.

The diameter (Dh) of the rivet head 102 is greater than the diameter (Ds) of the rivet shank 108. Thus, when the rivet shank 108 is inserted through aligned holes in the materials to be riveted together, the rivet 100 is prevented from passing entirely through the materials 202 and 204 as long as the diameter of the holes in the materials 202 and 204 are less than the diameter (Dh) of the rivet head 102.

FIG. 2 is a cross-sectional view of the rivet 100 of FIG. 1 holding two materials 202 and 204 together. Although, only two materials 202 and 204 are illustrated as being riveted together by rivet 100, three or more materials may be riveted together, depending upon the thickness of the materials and the length of the rivet shank 108.

As noted above, during the riveting process, the rivet shank 108 is inserted through the aligned holes of the materials 202 and 204. Depending upon the process, the rivet shank 108 may be inserted through the hole in the first material 202, and then later inserted through the hole in the second material 204. Alternatively, the materials 202 and 204 may be positioned together with their respective holes aligned such that the rivet shank 108 is inserted through the aligned holes in one step.

After the rivet shank 108 is inserted through the aligned holes of both materials 202 and 204, an anvil (not shown) is positioned against the exterior surface 106 of the rivet head 102. A hammer (not shown) is then used to deform the top portion 110 of the rivet shank 108 when the hammer applies a force to the top portion 110. In this illustrative example, the top portion 110 of the rivet shank 108 is deformed such that the top portion 110 contacts the second material 204 as shown.

Because the diameter (Dr) of the top portion of 110 of the rivet shank 108 is greater than the diameter of the aligned holes in the materials 202 and 204, and because the diameter (Dh) of the rivet head 102 (FIG. 1) is greater than the diameter of the aligned holes in the materials 202 and 204, the materials 202 and 204 are securely held together by the rivet 100. That is, the materials 202 and 204 have been riveted together.

In many riveting processes such as that described above, the insertion of the rivet shank 108 through the first material 202, or both materials 202 and 204, is performed by hand or performed by a device separate from the anvil. Accordingly, there will be a period of time when the rivet 100 is not held in place while the anvil is being positioned against the exterior surface 106 of the rivet head 102. During this time, the rivet 100 may slip out of position such that the riveting process cannot be completed.

### SUMMARY

The captive rivet system and method secures a captive rivet to a material. Briefly described, one embodiment is a captive rivet comprising a captive rivet head; a captive rivet shank coupled to the captive rivet head; and at least one capture region disposed on a lower portion of the captive rivet shank.

### BRIEF DESCRIPTION OF THE DRAWINGS

The components in the drawings are not necessarily to scale relative to each other. Like reference numerals designate corresponding parts throughout the several views.

FIG. 1 is a perspective view of a prior art standard tubular rivet.

FIG. 2 is a cross-sectional view of the rivet of FIG. 1 holding two materials together.

FIG. 3 is a perspective view of an embodiment of a captive rivet having a capture channel disposed in the lower portion of the captive rivet shank.

FIG. 4 is a cross-sectional view of a captive rivet system wherein the exemplary embodiment of a captive rivet of FIG. 3 is fastened to a material.

FIG. 5 is a cross-sectional view of the captive rivet of FIG. 4 fastened to a first material, and a second material adjacent to the first material.

FIG. 6 is a cross-sectional view of the captive rivet of FIG. 5 riveting the first and second materials together.

FIG. 7 is a block diagram of a captive rivet control system embodiment.

FIG. 8 is a diagram of a manual captive rivet system embodiment.

FIG. 9 is a cross-sectional view of an embodiment of the captive rivet system implemented in a “blind rivet” type of fastener.

FIG. 10 illustrates a simplified diagram of a captive rivet having a plurality of capture regions.

FIG. 11 illustrates a simplified diagram of a captive rivet forced into a deformed portion of the material so that the exterior surface of the captive rivet head is flush with the surface of the material.

FIG. 12 is a flowchart illustrating an embodiment of a process for riveting materials together using a captive rivet or a captive blind rivet.

FIG. 13 is a cross-sectional view of a captive rivet system wherein a second material is secured between a captive rivet and a first material.

### DETAILED DESCRIPTION

A captive rivet system provides a system and method for initially securing a captive rivet to a first material. After the captive rivet is inserted through a hole in the material, a captive rivet anvil is positioned against a head of the captive rivet. Then, a captive rivet hammer exerts force onto the material such that a portion of the material is deformed into a capture region of the captive rivet.

During later stages of the riveting process, the captive rivet is held in position relative to the first material by a deformed portion of the first material that extends into the capture channel to hold the captive rivet in place. Accordingly, the captive rivet is held securely in place such that the captive rivet shank may be inserted through an aligned hole in a second material, and/or such that the captive rivet shank may be deformed at a later time.

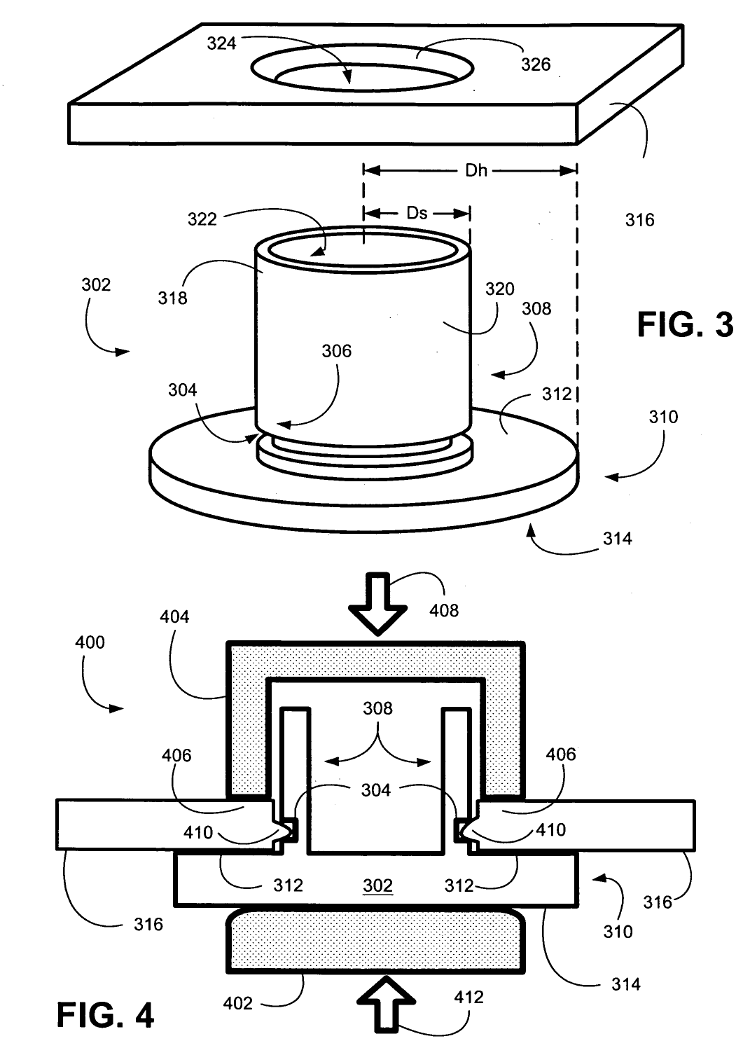

FIG. 3 is a perspective view of an embodiment of a captive rivet 302 comprising a capture region, illustrated as a radial capture channel 304, disposed in the lower portion 306 of the captive rivet shank 308. The captive rivet 302 comprises a captive rivet head 310 having an interior surface 312 and an exterior surface 314. Interior surface 312 is the surface of the captive rivet head 310 that contacts a first material 316 during the riveting process, described below. The exterior surface 314 of the captive rivet head 310 is supported by a captive rivet anvil 402 (FIG. 4) during the riveting process.

The captive rivet shank 308 includes an upper portion 318, an outside surface 320 and an inside surface 322. The lower portion 306 joins the captive rivet shank 308 and the captive rivet head 310.

As is also illustrated in FIG. 3, the first material 316 has a hole 324 disposed thereon. The side wall 326 of the hole 324 allows the captive rivet shank 308 to be initially inserted through the hole 324 without interference from the side wall 326.

FIG. 4 is a cross-sectional view of a captive rivet system 400 wherein the exemplary embodiment of a captive rivet 302 is fastened to first material 316. The captive rivet system 400 additionally comprises a captive rivet anvil 402 and a captive rivet hammer 404. During an initial stage of the riveting process, the captive rivet shank 308 is inserted through the hole 324 of the first material 316. At some point, the captive rivet anvil 402 is positioned against the exterior surface 314 of the captive rivet head 310. Accordingly, the captive rivet 302 is held in place between the captive rivet anvil 402 (in contact with the exterior surface 314) and the first material 316 (in contact with the interior surface 312).

Then, the captive rivet hammer 404 is brought into contact with a portion 406 of the first material 316. Sufficient force is exerted by the captive rivet hammer 404 onto the portion 406 (denoted by the directional arrow 408) to cause the first material 316 to deform such that a deformed portion 410 of material 316 extends into the capture channel 304. In another embodiment, described in greater detail below, the exterior surface 314 of the captive rivet head 310 is forced into the portion 406 such that the exterior surface 314 of the captive rivet head 310 is flush with the surface of the material 316.

After the captive rivet hammer 404 and the captive rivet anvil 402 are retracted away from the captive rivet 302 and the material 316, the deformed portion 410 residing in the capture channel 304 holds the captive rivet 302 in place. Accordingly, the riveting process can proceed to another stage whereby the captive rivet shank 308 may be inserted through an aligned hole of a second material. The secured captive rivet 302 will not slip out of position during later stages of the riveting process due to the above-described deformation.

In an alternative embodiment of the captive rivet system 400, the deforming force is exerted by the captive rivet anvil 402 after the captive rivet hammer 404 is placed in position against the material 316, as described above (denoted by the directional arrow 412). In yet another embodiment of the captive rivet system 400, both the captive rivet anvil 402 and the captive rivet hammer 404 exert force against the material 316 to cause deformation of the material 316 such that a deformed portion 410 of material 316 is forced into the capture channel 304 (denoted by the directional arrows 408 and 412).

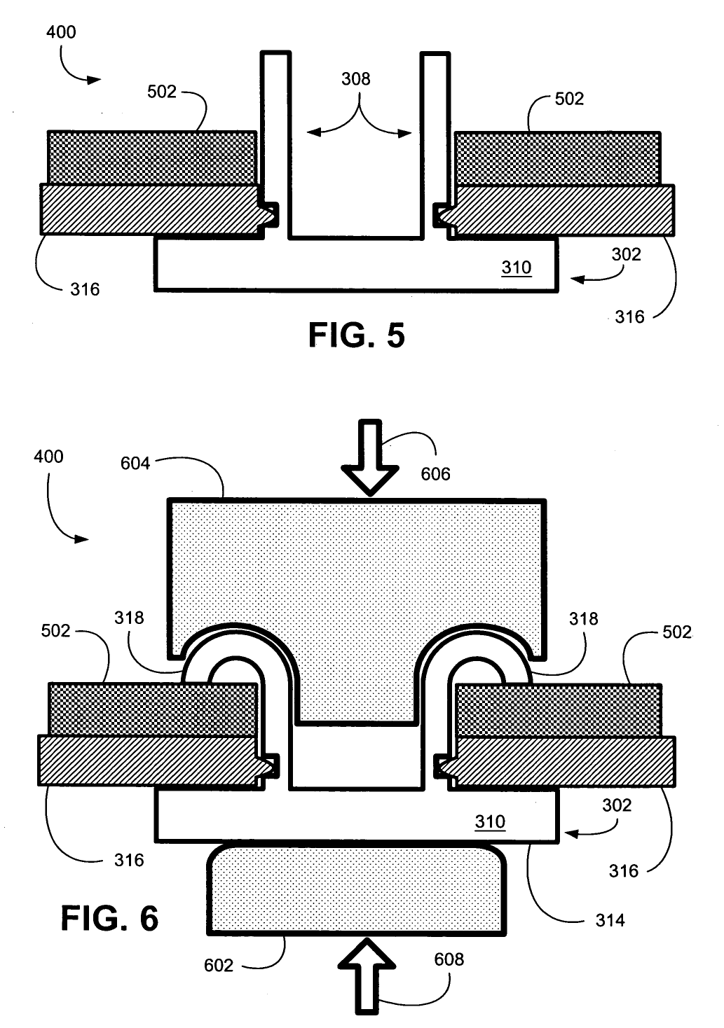

FIG. 5 is a cross-sectional view of the captive rivet 302 fastened to the first material 316, and a second material 502 adjacent to the first material 316. That is, the captive rivet shank 308 is aligned with, and then inserted through, a hole in the second material 502. Depending upon the application, holes in additional materials may be aligned with the captive rivet shank 308. Thus, the captive rivet shank 308 may be inserted through corresponding holes in the additional materials so that a plurality of materials may be riveted together. Regardless, the captive rivet 302 is fixed in position to the first material 316 so that it will not slip out of position during later stages of the riveting process.

FIG. 6 is a cross-sectional view of the captive rivet 302 riveting the materials 316 and 502 together. At this stage of the riveting process, an anvil 602 is positioned against the exterior surface 314 of the captive rivet head 310. A second hammer 604 is then forced onto the upper portion 318 of the captive rivet shank 308, thereby deforming the upper portion 318 (see FIG. 6) to complete the riveting process. Forces exerted by the second hammer 604 and/or anvil 602 are denoted by the directional arrows 606 and 608, respectively.

In some embodiments of the captive rivet system 400, the anvil 602 and the captive rivet anvil 402 (FIG. 4) are parts of the same device. In embodiments, however, the anvil 602 and the captive rivet anvil 402 are different devices. These different embodiments facilitate various riveting processes when stages of the riveting process are performed at substantially the same time or at different times, and/or when stages of the riveting process are performed at substantially the same location or at different locations.

The above-described riveting of the captive rivet 302 may be performed manually by a person using hand-held riveting tools. Alternatively, above-described riveting of the captive rivet 302 may be performed automatically by a riveting machine controlled by a riveting control system.

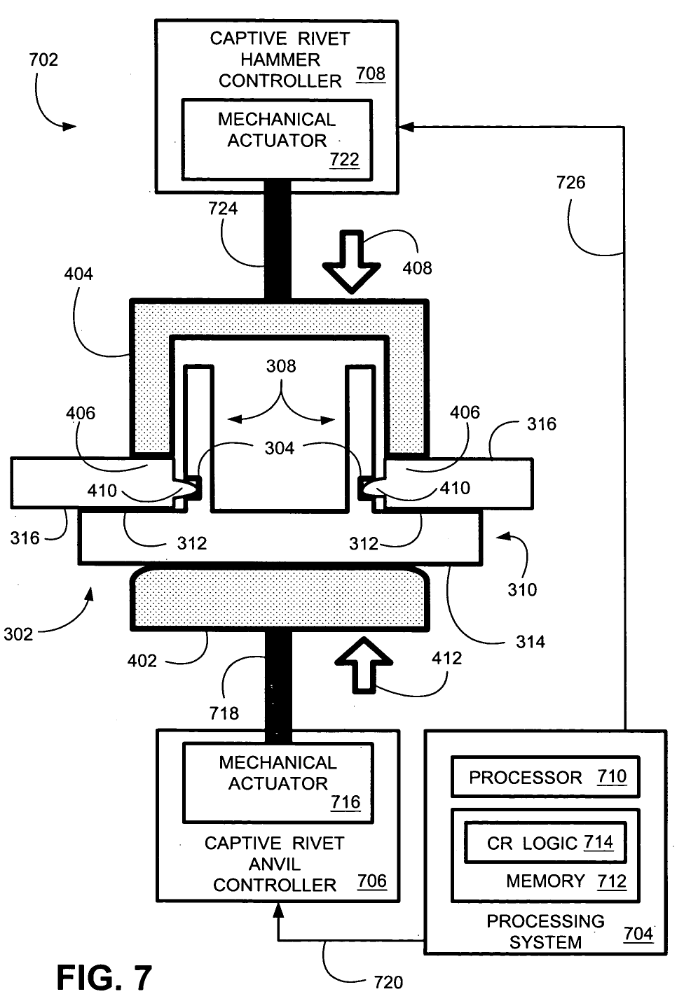

FIG. 7 is a block diagram of an automated captive rivet control system 702 embodiment. The captive rivet control system 702 comprises a processing system 704, a captive rivet anvil controller 706 and a captive rivet hammer controller 708. Processing system 704 comprises a processor 710 and a memory 712. Captive rivet (CR) logic 714 resides in memory 712, or alternatively, in another suitable memory medium (not shown).

In one embodiment, captive rivet anvil controller 706 controls a mechanical actuator 716 that provides support, and/or a force (indicated by directional arrow 412), to the exterior side 314 of the captive rivet head 310, as described above. The support and/or force is applied when the mechanical actuator 716 is actuated to exert force onto shaft 718 in an upward direction (relative to the embodiment illustrated in FIG. 7) in response to a signal communicated over connection 720. The communicated signal is generated by the processing system 704.

Similarly, captive rivet hammer controller 708 further controls a mechanical actuator 722 that provides a force (indicated by directional arrow 408), to the portion 406 of the material 316, as described above. The force is applied when the mechanical actuator 722 is actuated to exert force onto shaft 724 in a downward direction (relative to the embodiment illustrated in FIG. 7) in response to a signal communicated over connection 726. The communicated signal is generated by the processing system 704.

In alternative embodiments, the automated captive rivet control system 702 comprises only one of the mechanical actuator 722 or the mechanical actuator 716. Thus, the mechanical actuator 722, or the mechanical actuator 716, is used to exert the force that deforms the first material 316 into the capture region, thereby securing the captive rivet 302 to the first material 316.

Mechanical actuators 716 and 722 may be any suitable apparatus and/or system configured to actuate shafts 718 and 724, respectively. Such mechanical actuators may be pneumatically-based actuators using fluids (gasses or liquids), may be electrical motors, or may be electromechanical devices. Furthermore, mechanical actuators 716 and/or 722 may employ force multiplication devices, such as levers, gears or other suitable force-multiplication devices. Accordingly, mechanical actuators 716 and/or 722 exert sufficient force upon the portion 406 of the material 316 so that the deformed portion 410 is deformed into the capture channel 304, as described above.

At a later stage in the riveting process, another hammer controller (not shown) causes the second hammer 604 (FIG. 6) to deform the upper portion 318 (FIG. 3) of the captive rivet shank 308, thereby riveting the material 316 to a plurality of other materials. Accordingly, processing system 704 may be a stand-alone processing system configured to perform the captive riveting process described herein. Alternatively, processing system 704 may be integrated into a multi-function control system that performs other stages of a riveting process and/or other manufacturing process, such as when the other hammer controller causes the materials to be riveted together.

Processing system 704 is illustrated for convenience as having at least processor 710 and memory 712. Processing system 704 controls the execution of the CR logic 714. Any suitable processor system 704 may be employed in various embodiments of a captive rivet control system 702. Processing system 704 may be a specially designed and/or fabricated processing system, or a commercially available processor system.

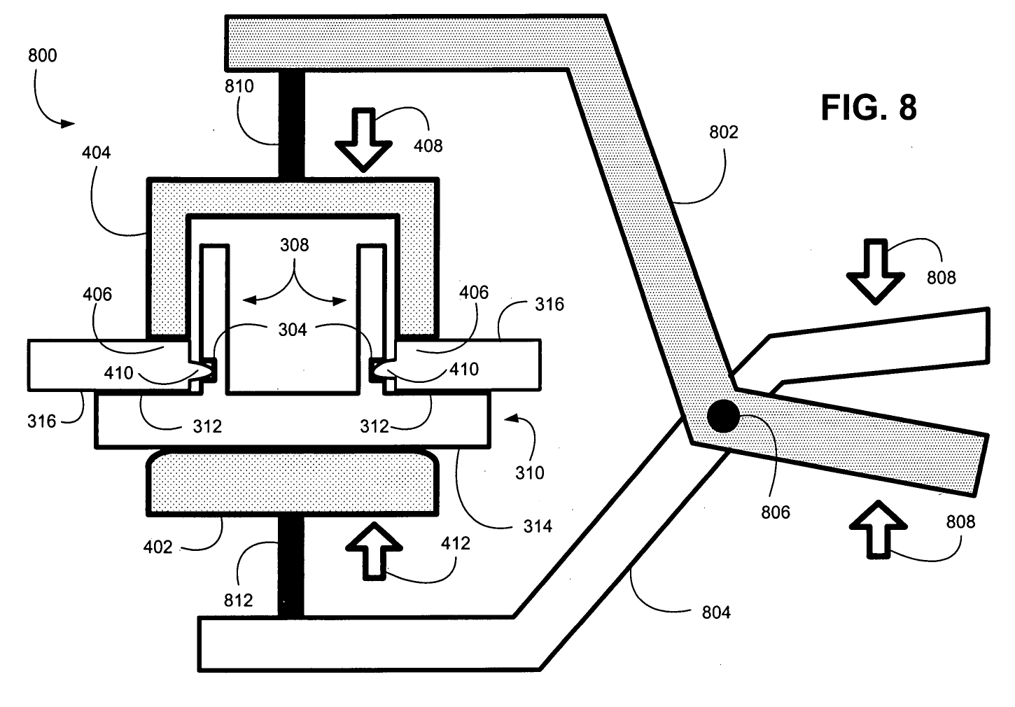

FIG. 8 is a diagram of a manual captive rivet system 800 embodiment. The manual captive rivet system 800 comprises a first member 802 and a second member 804, coupled together with a suitable fastener 806. Fastener 806 may be a pin, hinge, peg, dowel, bolt, rod, bearing or other suitable fastening device.

The fastening means provides for conversion of a manual force exerted by a user (denoted by directional arrows 808) into a mechanical force exerted on shafts 810 and 812 (denoted by the directional arrows 408 and 412, respectively). The process of exerting sufficient force upon the portion 406 of the material 316 so that the deformed portion 410 is deformed into the capture channel 304 has been described above.

Shafts 810 and/or 812 are optional in some embodiments. That is, the captive rivet hammer 404 may be directly coupled to first member 802, and/or the captive rivet anvil 402 may be directly coupled to second member 804.

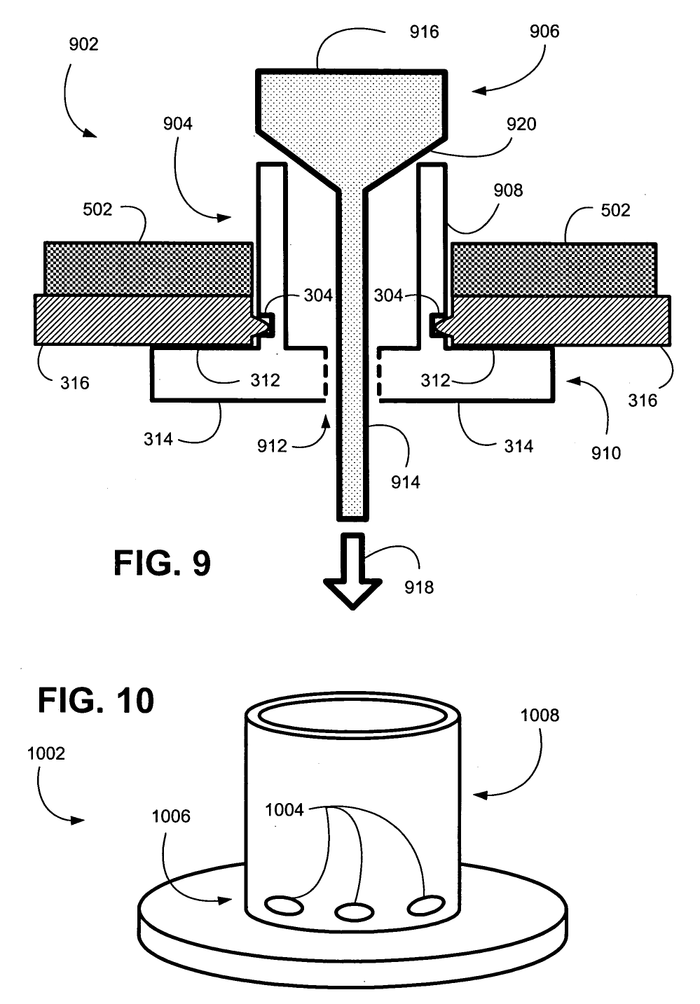

FIG. 9 is a cross-sectional view of an embodiment of the captive rivet system 400 (FIGS. 4-6) implemented for a “blind rivet” type of fastener. There are many types of conventional blind rivet type fasteners. These types of conventional blind rivet type fasteners may be modified into embodiments of a captive blind rivet 902 by adding at least one capture region, such as the illustrated radial capture channel 304, to the blind rivet. Captive blind rivets 902 may be desirable when it is not possible to position a captive rivet anvil 402 (FIGS. 3-8) to provide support to a captive rivet head 310.

A captive blind rivet 902 comprises a first rivet member 904 and a second rivet member 906. The illustrated first rivet member 904 comprises a captive rivet shank 908 having a capture channel 304 disposed thereon, and a captive rivet head 910, similar to the above-described embodiments of the captive rivet head 310. However, a portion of the first rivet member 904 provides a hole 912 therethrough.

The illustrated second rivet member 906 comprises a shaft 914, that is configured to pass through hole 912, and a protrusion 916. For convenience, the protrusion 916 is illustrated at the top end of the second rivet member 906 in this exemplary embodiment. Depending upon the specific type of captive blind rivet, this protrusion may be elsewhere on the shaft 914.

As described above, the capture channel 304 disposed on the captive rivet shank 908 allows a portion of the material 316 to be deformed into the capture channel 304 as described above, so as to secure the first rivet member 904 to the material 316. For convenience, FIG. 9 also illustrates the second material 502 adjacent to material 316, as described above for FIG. 5. To complete the riveting process, the shaft 914 is forcibly moved in the direction indicated by the directional arrow 918. As a wedge portion 920 of the protrusion 916 is drawn down into contact with the captive rivet shank 908, the captive rivet shank 908 is deformed such that the materials 316 and 502 are riveted together.

For convenience of illustration, the capture channel 304 illustrated in FIGS. 3-9 was illustrated as having side walls perpendicularly oriented with the bottom of the channel. Other embodiments employ other configurations of a capture region. For instance, the side walls may be slanted and/or may be curvilinear, depending upon the particular riveting process used.

Moreover, alternative embodiments employ other types of capture regions disposed on a captive rivet shank. These various capture regions are configured to receive a deformed portion of the material 316, thereby securing the captive rivet to the material 316 (FIGS. 3-9). For example, the capture regions of a captive rivet shank may be configured as a recess, cavity, indentation or hole of a selectable shape and depth, depending upon the specific application used for the riveting process. Furthermore, one or more captive regions may be employed by various embodiments.

FIG. 10 illustrates a simplified diagram of a captive rivet 1002 having a plurality of capture regions 1004 disposed on the lower portion 1006 of a captive rivet shank 1008. Examples of capture regions 1004 include holes, indentations or protrusions. Such embodiments may be implemented on various embodiments of a captive rivet or a captive blind rivet.

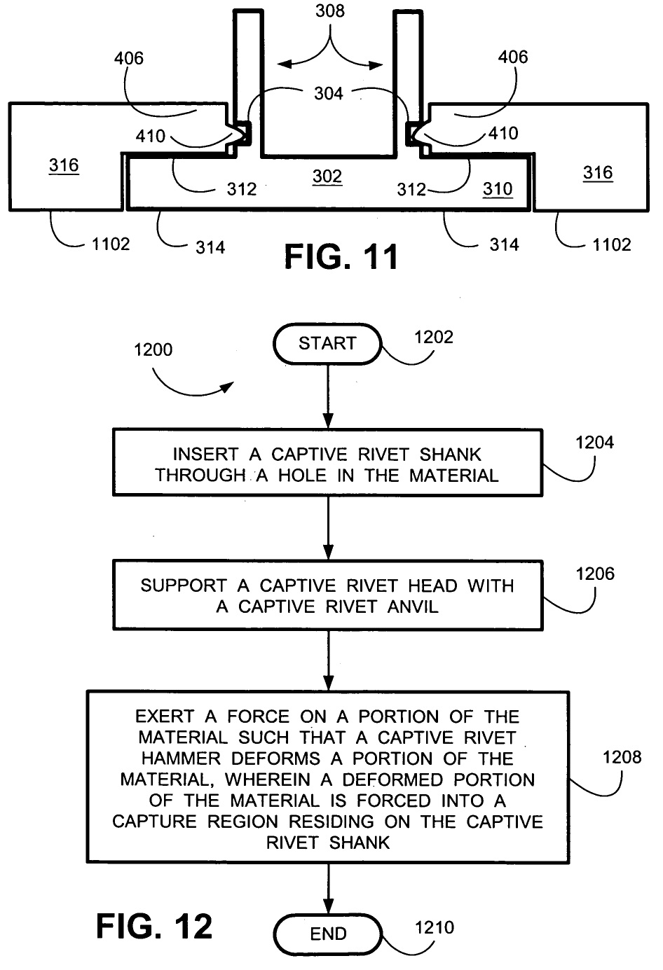

FIG. 11 illustrates a simplified diagram of a captive rivet 302 forced into the deformed portion 410 of the material 316 so that the exterior surface 314 of the captive rivet head 310 is flush with the surface 1102 of the material 316. An optional recess may be included in the first material 316 so that the amount of material that is deformed to accommodate the captive rivet head 310 is reduced. With this embodiment, force may be exerted to push the captive rivet head 310 into material 316 concurrently with the force that deforms the portion 410 into the capture channel 304.

When the exterior surface 314 of the captive rivet head 310 is flush with the surface 1102 of material 316, movement of the exterior surface 314 and surface 1102 along the surface of another material is facilitated. Furthermore, the captive rivet head 310 will become embedded in the material 316 such that when used in certain environments, the captive rivet 302 will not move in an undesirable manner. For example, if the captive rivet 302 is used in an automobile, the embedded captive rivet 302 will not rattle or vibrate in an undesirable manner when the automobile is travelling on a bumpy or rough surface. Such undesirable vibration may have otherwise caused an undesirable sound, or may have resulted in premature fatigue and/or failure of the captive rivet 302 and/or material 316.

FIG. 12 shows a flow chart 1200 illustrating a process used by an embodiment of a captive rivet control system 702 (FIG. 7). The flow chart 1200 of FIG. 12 shows the architecture, functionality, and operation of an embodiment for implementing the captive rivet logic 714 (FIG. 7) such that a captive rivet 302 (FIG. 3) or a captive blind rivet 902 (FIG. 9) is securely fixed to a first material. An alternative embodiment implements the logic of flow chart 1200 with hardware configured as a state machine. In this regard, each block may represent a module, segment or portion of code, which comprises one or more executable instructions for implementing the specified logical function(s). It should also be noted that in alternative embodiments, the functions noted in the blocks may occur out of the order noted in FIG. 12, or may include additional functions. For example, two blocks shown in succession in FIG. 12 may in fact be substantially executed concurrently, the blocks may sometimes be executed in the reverse order, or some of the blocks may not be executed in all instances, depending upon the functionality involved, as will be further clarified hereinbelow.

The process begins at block 1202. At block 1204, a captive rivet shank is inserted through a hole in the material. At block 1206, a captive rivet head is supported with a captive rivet anvil. At block 1208, a force is exerted on a portion of the material such that a captive rivet hammer causes a deformation of a portion of the material, wherein a deformed portion of the material is forced into a capture region residing on the captive rivet shank, thereby securing the captive rivet to the material. The process ends at block 1210.

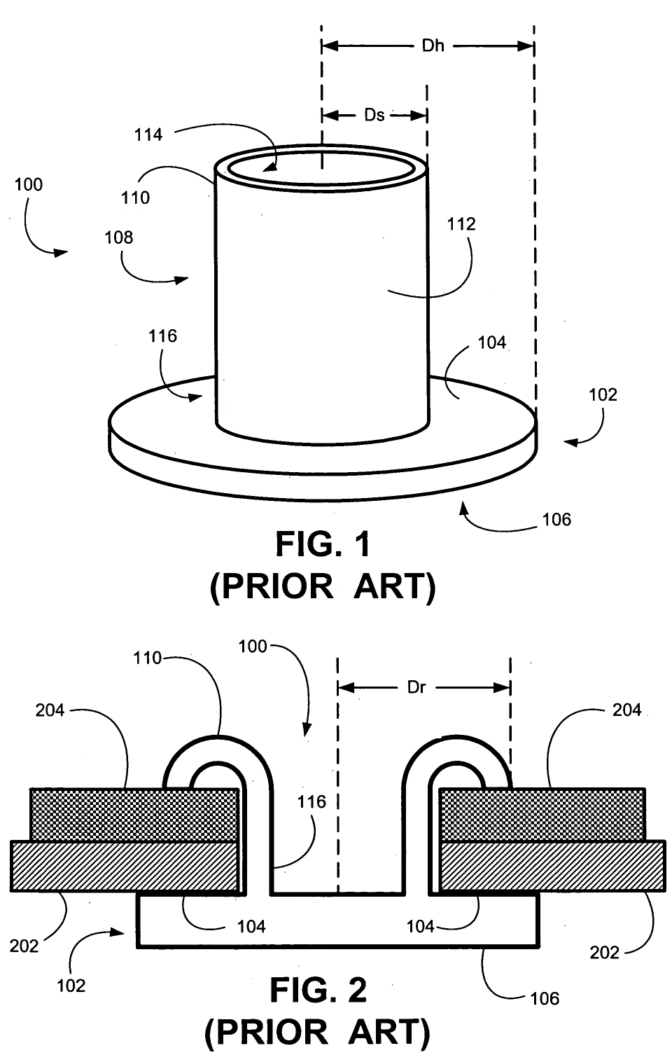

Embodiments implemented in memory 712 (FIG. 1) may be implemented using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

Some embodiments of a captive rivet may be headless. In such embodiments, the captive rivet anvil (or another anvil) may cause deformation of the headless end of the captive rivet when the captive rivet hammer (or another hammer) applies force to the captive rivet, in addition to the forces deforming the upper portion 318 of the captive rivet shank 308 (FIGS. 3-8).

Captive rivets may be further categorized by the type of captive rivet head and/or the type of captive rivet shank. A universal captive rivet has a captive rivet head that extends above the surface of the riveted materials. A countersunk captive rivet has a captive rivet head that is configured to fit into a recess formed in an outer surface of the riveted material. Captive rivet shanks may be tubular or solid. A tubular captive rivet shank has a portion of the captive rivet shank removed such that a portion of the shank is hollow. The captive rivet shank may be semi-tubular wherein only a portion of the shank is hollow, or the captive rivet shank may be full-tubular wherein substantially all of the shank is hollow. Other captive rivet shanks may be solid. Also, solid or tubular captive rivet shanks may be split to facilitate rivet deformation.

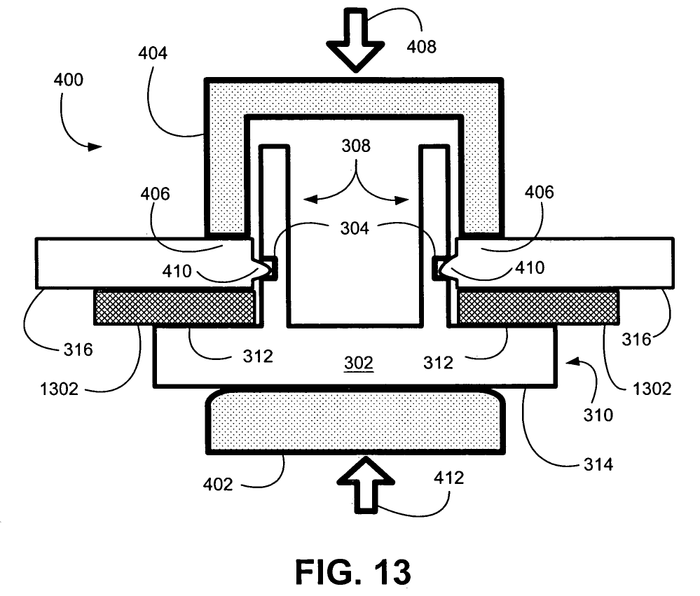

FIG. 13 is a cross-sectional view of a captive rivet system wherein a second material 1302 is secured between a captive rivet 302 and a first material 136. In this embodiment, one or more other materials are placed onto the rivet shank 308 before, or with, the first material 316, thereby becoming “sandwiched” between the captive rivet head 310 and the first material 316. When the deformed portion 410 secures the captive rivet 302, the other materials are also thereby secured.

It should be emphasized that the above-described embodiments are merely examples of the disclosed system and method. Many variations and modifications may be made to the above-described embodiments. All such modifications and variations are intended to be included herein within the scope of this disclosure and protected by the following claims.

1. A product comprising:
at least one captive rivet, the captive rivet comprising at least one capture region disposed on a lower portion of a captive rivet shank;
a first material secured to the captive rivet, wherein a deformed portion of the first material is deformed into the capture region.

2. The product of claim 2, wherein a captive rivet hammer causes a deformation of a portion of the first material such that the deformed portion of the first material is forced into the capture region, thereby securing the captive rivet to the first material.

3. The product of claim 1, further comprising a second material, wherein the second material is secured to the first material by an upper portion of the captive rivet shank that has been deformed.

4. The product of claim 1, further comprising a plurality of materials, wherein the plurality of materials are secured to the first material by an upper portion of the captive rivet shank that has been deformed.

5. The product of claim 1, further comprising a plurality of captive rivets secured to the first material.

6. The product of claim 1, further comprising at least a second material, wherein the second material is secured to the first material by a plurality of captive rivets, each captive rivet having an upper portion of their captive rivet shank that has been deformed.

7. The product of claim 1, further comprising a second material, wherein the second material is secured between the first material and a captive rivet head of the captive rivet.

8. A riveting system, comprising:
a captive rivet anvil configured to support a captive rivet, the captive rivet comprising at least one capture region disposed on a lower portion of a captive rivet shank; and
a captive rivet hammer configured to deform a portion of the material such that a deformed portion of the material is forced into the capture region, thereby securing the captive rivet to the material.

9. The system of claim 8, further comprising:
a first member coupled to the captive rivet anvil; and
a second member coupled to the first member and the captive rivet hammer, wherein a manual force exerted on the first member and the second member is converted into a mechanical force exerted on the material that deforms the portion of the material.

10. The system of claim 8, further comprising:
a captive rivet anvil controller coupled to the captive rivet anvil;
a captive rivet hammer controller coupled to the captive rivet hammer; and
a processing system configured to communicate a signal wherein a force is exerted on the captive rivet that deforms the portion of the material.

11. The system of claim 10, wherein the captive rivet anvil controller comprises a mechanical actuator, such that the communicated signal causes the mechanical actuator to exert the force on the captive rivet anvil.

12. The system of claim 10, wherein the captive rivet hammer controller comprises a mechanical actuator, such that the communicated signal causes the mechanical actuator to exert the force on the captive rivet hammer.

13. The system of claim 10, wherein the processing system comprises:
a memory;
captive rivet logic residing in the memory; and
a processor coupled to the memory such that when the captive rivet logic is executed by the processor, the processing system communicates the signal.

14. The system of claim 8, further comprising a second hammer, the second hammer configured to exert a force deforming an upper portion of the captive rivet shank such that the deformed upper portion of the captive rivet shank rivets the material to at least one second material.

15. A captive rivet comprising:
a captive rivet head;
a captive rivet shank coupled to the captive rivet head; and
at least one capture region disposed on a lower portion of the captive rivet shank.

16. The captive rivet of claim 15, wherein an exerted force causes a captive rivet hammer to deform a portion of material such that a deformed portion of the material is forced into the capture region, thereby securing the captive rivet to the material.

17. The captive rivet of claim 15, further comprising a plurality of capture regions disposed on the captive rivet shank.

18. The captive rivet of claim 15, wherein the capture region comprises a capture channel.

19. The captive rivet of claim 15, wherein a second hammer deforms an upper portion of the captive rivet shank such that the deformed upper portion of the captive rivet shank rivets the material to at least one second material.

20. The captive rivet of claim 15, further comprising:
a rivet member;
a shaft residing on the rivet member and extending through a hole in the captive rivet head; and
a protrusion residing on the rivet member, wherein retraction of the shaft through the hole causes the protrusion to deform an upper portion of the captive rivet shank such that the deformed upper portion of the captive rivet shank rivets the material to at least one second material.

21. A method for securing a captive rivet to a material comprising:
inserting a captive rivet shank through a hole in the material;
supporting a captive rivet head with a captive rivet anvil; and
exerting a force on a portion of the material such that a captive rivet hammer deforms a portion of the material, wherein a deformed portion of the material is forced into a capture region residing on the captive rivet shank, thereby securing the captive rivet to the material.

22. The method of claim 21, further comprising exerting the force with the captive river hammer.

23. The method of claim 21, further comprising exerting the force with the captive river anvil.

24. The method of claim 21, further comprising:
communicating a signal from a processing system to a captive rivet controller; and
exerting the force from a mechanical actuator in response to the communicated signal.

25. The method of claim 24, further comprising:
communicating the signal from the processing system to a captive rivet anvil controller; and
actuating the mechanical actuator to exert a mechanical force onto the captive rivet anvil in response to the communicated signal.

26. The method of claim 24, further comprising:
communicating the signal from the processing system to a captive rivet hammer controller; and
actuating the mechanical actuator to exert a mechanical force onto the captive rivet hammer in response to the communicated signal.

27. The method of claim 21, further comprising manually exerting a second force onto a first member and a second member such that the exerted second force is converted by the first member and the second member into the exerted force on the portion of the material.

28. A system for securing a captive rivet to a material, comprising:
means for supporting a captive rivet head with a captive rivet anvil; and
means for exerting a force on a portion of the material such that a captive rivet hammer deforms a portion of the material such that a deformed portion of the material is forced into a capture region residing on a captive rivet shank, thereby securing the captive rivet to the material.

29. The system of claim 28, further comprising means for converting a manual force exerted on a first member and a second member into the exerted force on the portion of the material.

30. The system of claim 28, further comprising
means for communicating a signal to a captive rivet anvil controller; and
means for actuating the captive rivet anvil controller to generate a force onto a captive rivet anvil in response to the communicated signal.

31. The system of claim 28, further comprising:
means for communicating the signal to a captive rivet hammer controller; and
means for actuating the captive rivet hammer controller to generate a force onto the captive rivet hammer in response to the communicated signal.

32. A computer-readable medium having a program for securing a captive rivet to a material, the program comprising logic configured to generate a signal that is communicated to a captive rivet controller that actuates a mechanical controller to deform a portion of the material such that a deformed portion of the material is forced into a capture region residing on a shank of the captive rivet, thereby securing the captive rivet to the material.

33. The computer-readable medium of claim 32, wherein the generated signal is communicated to a captive rivet anvil controller such that the mechanical controller exerts a force onto a captive rivet anvil in response to the communicated signal.

34. The computer-readable medium of claim 32, wherein the generated signal is communicated to a captive rivet hammer controller such that the mechanical controller exerts a force onto a captive rivet hammer in response to the communicated signal.
